(19) United States
(12) Patent Application Publication
(10) Pub. No.: US 2004/0079159 A1
(43) Pub. Date: Apr. 29, 2004

(54) Micromechanical pressure sensor device and corresponding measurement system

(76) Inventor: Joerg Muchow, Pliezhausen (DE)

Correspondence Address: KENYON & KENYON, ONE BROADWAY, NEW YORK, NY, 10004, US

(21) Appl. No.: 10/618,326

(22) Filed: Jul. 10, 2003

(30) Foreign Application Priority Data
Jul. 13, 2002 (DE) 102 31 727.5

(51) Int. Cl. G01L 13/02

(52) U.S. Cl. 73/716

(57) ABSTRACT

A micromechanical pressure sensor device, particularly for measuring low absolute pressures and/or small differential pressures. The device includes a frame that is formed at least partially by a semiconductor material, a membrane retained by the frame, at least one measuring resistor that is disposed at a first location in or on the membrane and whose resistance value is a function of pressure-induced mechanical stresses in the membrane, and at least one compensating resistor that is disposed at a second location in or on the membrane and whose resistance value is a function of pressure-induced mechanical stresses in the membrane. The resistance value changes at the first location with a first linear component and a first quadratic component as a function of the pressure, and the resistance value changes at the second location approximately without a linear component and with a second quadratic component, which is proportional to the first quadratic component, as a function of the pressure.

### FIELD OF THE INVENTION

The present invention relates to a micromechanical pressure sensor device and a corresponding measuring system.

### BACKGROUND INFORMATION

German Patent Application No. 197 01 055 describes a micromechanical pressure sensor which has a frame made from a semiconductor substrate and a membrane disposed on the frame. Mounted on the membrane are four piezoresistive measuring resistors whose resistance values change in response to a deformation of the membrane, i.e., of the resistors (as a result of a differential pressure between the upper side and the lower side of the membrane). In each case, two of the four resistors lie parallel to one another near the middle of the boundary lines of the membrane. Moreover, the pressure sensor has four compensating resistors, of which in each case two are arranged parallel to each other and perpendicular to the measuring resistors on the frame of the pressure sensor. All the resistors form a Wheatstone measuring bridge whose output signals are tapped off at corners of the sensor lying diagonally opposite each other.

The output voltage of the measuring bridge as a function of the differential pressure between the two sides of the membrane exhibits an unwanted nonlinearity, particularly when measuring small differential pressures.

European Patent Patent No. 0 833 137 describes a micromechanical pressure sensor device which is explained in greater detail with reference to FIG. 9. In FIG. 9, reference numeral 110 designates a semiconductor substrate in which is formed a membrane 101. Formed on membrane 101 and surrounding substrate 110 is an epitaxy layer 108 that is used as support for transducers 102, 103, for example, in the form of piezoresistors. The transducers convert a stress, which results from a deformation of membrane 101 because of a differential pressure, into an electrical signal that is supplied to a compensation circuit 104. First transducer 103 is positioned at a location having substantial stress, at which it generates a signal having a linear component and a non-linear component as a function of the differential pressure. Second transducer 102 is positioned at a location without stress, at which it generates a signal having no linear component and the non-linear component as a function of the differential pressure. Compensation circuit 104 adds the signals from both transducers 102, 103, in order to eliminate the non-linear component.

International Patent Application No. WO 01/40751 describes a further micromechanical pressure sensor device, particularly for measuring low absolute pressures and/or small differential pressures. It includes a frame, that is formed at least partially by a semiconductor material, a membrane held by the frame, at least one measuring resistor that is positioned at a first location in or on the membrane and whose resistance value is a function of the deformation of the membrane, and at least one compensating resistor that is disposed at a second location in or on the membrane and whose resistance value is a function of the deformation of the membrane. In response to a deformation of the membrane, bending stresses and membrane stresses occur, the bending stresses exhibiting a spatial distribution on the membrane. At the first location, approximatively maximum bending stresses occur, and at the second location, approximatively minimum bending stresses occur.

Thus, as regards EP 0 833 137 and WO 01/40751, the assumption has been that an optimum location for the membrane compensating resistor(s) in the membrane is that at which a “minimum” bending stress of the membrane is present. Meant by this was apparently a zero value of the radial bending stress σ₁, ignoring the influence of the tangential bending stress σₜ, because a location at which both are zero simultaneously cannot be found.

The problem upon which the present invention is based is that this approach for the location of the membrane compensating resistor(s) leads to unsatisfactory results, that is to say, it does not sufficiently eliminate the nonlinearity of the output characteristic of the pressure sensors in question.

### SUMMARY

A micromechanical pressure sensor device according to an example embodiment of the present invention may have the advantage that the unwanted nonlinearity, particularly at small differential pressures (between 0 and 50 mbar), may be better compensated, which means pressure measurements may be carried out more precisely using the example micromechanical pressure sensor device according to the present invention.

In addition to the radial stress, the tangential stress is also taken into account, which likewise has an effect on the relative change in resistance. Resulting therefrom with respect to the position of the compensating resistor(s) is a shift in the direction of the middle of the membrane in comparison to the related art.

The result is that the resistance value changes at the first location with a first linear component and a first quadratic component as a function of the pressure, and the resistance value changes at the second location approximatively without a linear component and with a second quadratic component, which is proportional to the first quadratic component, as a function of the pressure. The proportionality results generally from the different sensitivity, and is able to be compensated by a suitable electronic amplification.

Since the output signal of the Wheatstone measuring bridge, formed from the measuring resistors, also exhibits a nonlinear, particularly quadratic relationship of dependence on the differential pressure, the output signal of the Wheatstone measuring bridge may be compensated by the output signal of the compensating bridge directly or indirectly after a conversion of the respective output signals into a different electrical quantity like, for example, an electric current. By suitable tapping of the output voltage of the compensating bridge, a voltage is obtained as a function of the differential pressure, which has an inverted sign with respect to the output voltage of the Wheatstone measuring bridge. It is thereby possible to compensate the quadratic dependence of the output voltage of the Wheatstone measuring bridge in a particularly simple manner from the technical standpoint, which is discussed in greater detail below.

It may be particularly advantageous to arrange on the membrane, four measuring resistors that are interconnected as a Wheatstone measuring bridge, and to compensate the output signal of this Wheatstone measuring bridge with the output signal of a further Wheatstone measuring bridge, the further Wheatstone measuring bridge, a so-called compensating bridge, being formed by two compensating resistors provided in the membrane and two frame resistors disposed in the frame of the sensor.

To increase the sensitivity, it may be advantageous in each instance to provide the measuring resistors at a location of the membrane which undergoes a maximum longitudinal or a maximum transverse bending stress with respect to the current direction of the membrane, a maximum change in resistance thereby being brought about. In the low-pressure range, such a Wheatstone measuring bridge, formed from the measuring resistors, exhibits a nonlinearity as a function of the pressure of approximately 1 to 2 percent.

In one preferred specific embodiment, the compensation is effected by subtraction of the output voltages of the Wheatstone measuring bridge and of the compensating bridge, each converted into electric currents. To that end, the output signal of the Wheatstone measuring bridge, a pressure-dependent electrical voltage, is supplied to a first voltage-/current transducer (UI transducer), and the output signal of the compensating bridge, likewise a pressure-dependent electrical voltage, is supplied to a second voltage-/current transducer. The currents generated by the two UI transducers have an inverted sign, and by the subtraction of the two electric currents, a resulting electric current is yielded whose current intensity exhibits a substantially linear characteristic as a function of the pressure.

To ensure the linearity of the pressure sensor device according to the present invention, one example embodiment of the present invention provides for amplifying the output signal of the compensating bridge or an electrical quantity corresponding to the output signal of the compensating bridge, like, in particular, an electric current proportional to the output signal or to the output voltage, and to use the amplified electrical quantity to compensate for the nonlinearity of the Wheatstone measuring bridge. It is therefore possible to take into account the various pre-factors of the quadratic component.

The output signal of the compensating bridge, or the electrical quantity adequate to this signal, is preferably amplified by a factor such that the output signal of the Wheatstone measuring bridge (i.e., the electrical quantity adequate to this output signal), compensated by the amplified electrical quantity, exhibits a substantially linear behavior. Of course, the electrical quantity formed from the nonlinear output signal of the compensating bridge and utilized for the compensation must not be amplified too strongly, in order to avoid an over-compensation and a nonlinearity resulting therefrom.

Furthermore, it may be particularly advantageous if the frame of the pressure sensor device and preferably also the membrane are formed completely or partially by silicon, since this material permits the integration of sensor element and measuring system, i.e., evaluation electronics, on one chip.

Finally, it is also particularly advantageous to produce the frame and the membrane from a silicon substrate that is used in a (100)-orientation. The membrane may thereby be easily produced by etching the silicon substrate with a potassium hydroxide etching solution. In addition, a silicon substrate having this orientation has two [011]-directions in the substrate surface in which the conductivity reacts particularly sensitively to the deformation of the membrane. The measuring resistors and the compensating resistors are preferably formed by locally doped regions in the membrane and in the frame, respectively.

To reduce the current consumption of the micromechanical pressure sensor device according to the present invention, it is particularly advantageous if the measuring resistors and/or the compensating resistors have an electrical resistance greater than 1 kΩ.

### BRIEF DESCRIPTION OF THE DRAWINGS

The present invention is explained more precisely in the following with reference to drawings that are not necessarily true to scale, identical reference numerals designating identical or equally-acting layers or parts.

FIG. 1 shows a representation of the principle of the micromechanical pressure sensor device according to an example embodiment of the present invention in plan view.

FIG. 2 shows a preferred example embodiment of a micromechanical pressure sensor device according to the present invention in plan view.

FIG. 3 shows the pressure sensor according to the present invention of FIG. 2 along the line of intersection A-B of FIG. 2 in cross-section.

FIG. 4 shows a block diagram of a compensation circuit for use with the example micromechanical pressure sensor device of the present invention.

FIG. 5 shows a further example embodiment of a micromechanical pressure sensor device according to the present invention in plan view.

FIG. 6 shows a schematic representation of the configuration of the compensating resistors according to the present invention in comparison to the configuration in the case of the pressure sensor device described in EP 0 833 137 or WO 01/40751.

FIG. 7 shows a representation of output signal S_{K} (mV) of the pressure sensor device, having compensating resistors arranged according to EP 0 833 137 A2, as a function of applied differential pressure ΔP (bar).

FIG. 8 shows a representation of output signal S_{K} (mV) of the pressure sensor device, having compensating resistors arranged according to the present invention, as a function of applied differential pressure ΔP (bar).

FIG. 9 shows a pressure sensor device described in EP 0 833 137.

### DESCRIPTION OF EXAMPLE EMBODIMENTS

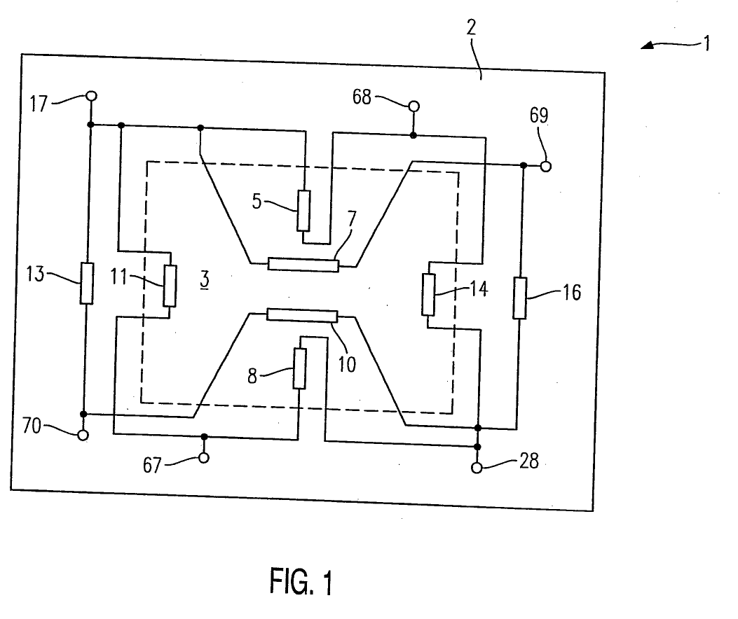

Pressure sensor 1, portrayed in a basic representation in FIG. 1, has a frame 2 formed from a silicon substrate, and a membrane 3 held by the frame at its top surface.

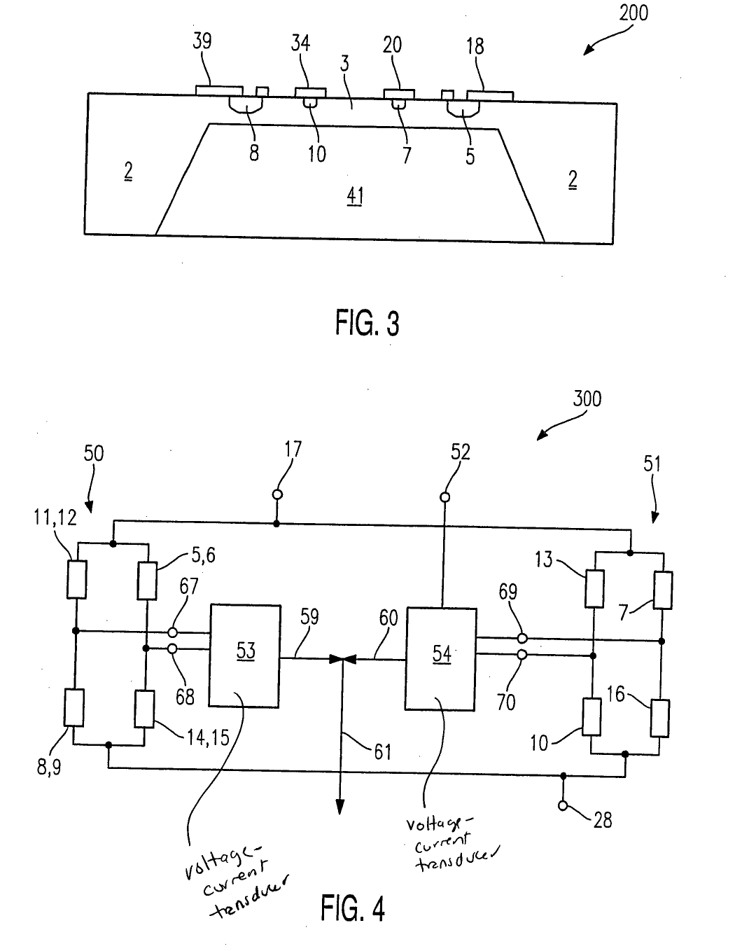

Frame 2 and membrane 3 are formed from a silicon substrate by masking and subsequent etching of the back side of pressure sensor 1 shown in FIG. 1. A potassium hydroxide etching solution (KOH etching solution) is preferably used for producing a cavity having a truncated pyramid shape tapering in the direction of the lower side of membrane 3 and having a trapezoidal cross-section—with respect to the cavity, see cavity 41 in FIG. 3. The truncated-pyramid-shaped cavity below membrane 3 is yielded in the preferred use of a silicon substrate, which has a (100)-orientation, because a KOH etching solution exhibits different etching rates in the [100]- and the [110]-crystal direction of silicon.

The preferably rectangular membrane 3, which is represented in FIG. 1 by a square with a dotted outline or membrane edges, typically has a thickness of approximately 5 to 80 μm. A membrane edge “separates” frame 2 from membrane 3.

Of course, the membrane may also be thinner or thicker depending on the specific application purpose of a pressure sensor according to the present invention. In the same way, it is possible to use the concepts of the present invention on membranes which have regions with different thickness. Examples of such membranes are membranes having a flexurally stiff center (so-called boss membranes) and/or having flexurally stiff edge areas. Moreover, it may be expedient to use a pressure sensor of the present invention having a membrane which has a different outline.

Membrane 3 of the present invention according to FIG. 1 has a measuring resistor 5, a compensating resistor 7, a measuring resistor 8 and a compensating resistor 10, as well as two further measuring resistors 11 and 14. Two further compensating resistors 13 and 16 are provided outside of membrane 3 on frame 2.

One possibility for producing a resistor situated below the membrane is to infuse p-doped regions into an n-doped membrane (base diffusion). An epitaxial layer is then subsequently grown, and the membrane is etched by a so-called pn-stop.

The resistors are preferably piezoresistive resistors having, in plan view, a substantially rectangular contour, whose resistance value changes in response to a mechanical deformation of the resistor or of the membrane at the location of the resistor in question. The resistors are preferably formed by suitably doped regions of the membrane.

Of course, instead of a masking process step and subsequent doping process step of the membrane, resistors which are formed differently may also be used, whose resistance value is likewise a function of the deformation of the resistor in question, and which are provided, for example, on, in or below the membrane. For example, a resistor provided on or below the membrane could be produced by masking the membrane in the region of the resistor to be produced, and subsequent coating with a suitable material. In the same way, a “buried” resistor may be produced in the membrane.

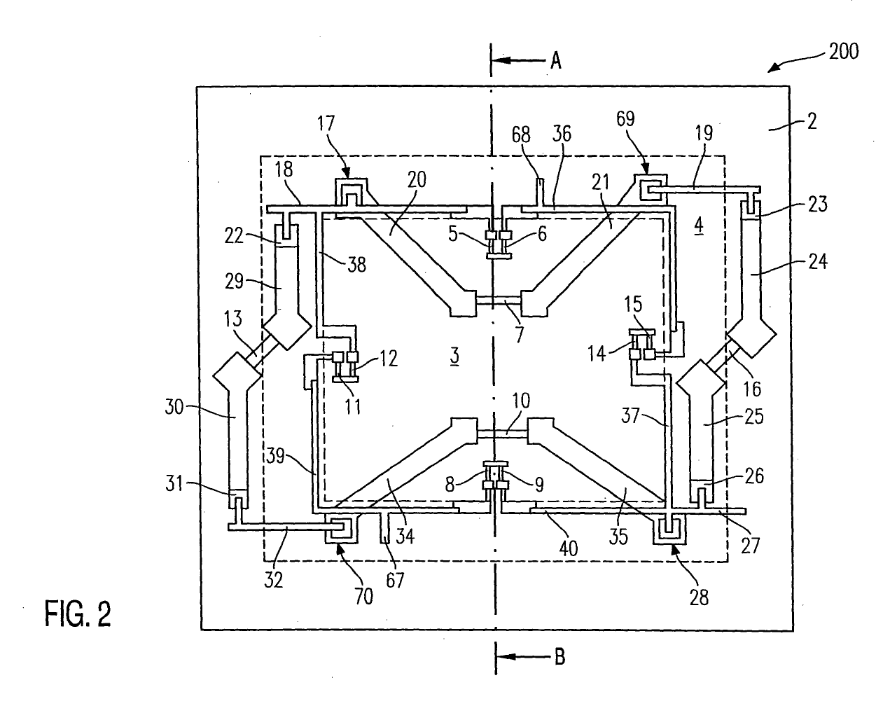

As will become clear, especially from the following functional description, the subsequently described geometry of the pressure sensor according to the present invention is merely a preferred specific embodiment of the invention. Thus, compensating resistors 7 and 10, situated in FIG. 2 on the outline of an imaginary, rounded-off rectangle, may in each case also be situated at a different point of such an outline. In the case of a square membrane, the outline in question would be, let us say, a rounded-off square, and for a circular membrane, would be a circle.

If one compares membrane 3, shown in FIG. 1, to the face of a clock, then the longitudinal axis of measuring resistor 5, which, like all other piezoresistive resistors, has, in plan view, a substantially rectangular contour, is pointing in the direction of “twelve o'clock”, and is introduced into membrane 3 near the upper edge of the membrane.

The longitudinal axis of compensating resistor 7 runs transversely with respect to the longitudinal axis of measuring resistor 5, and an imaginary mid-perpendicular to its longitudinal axis coincides approximately with the longitudinal axis of measuring resistor 5. Compensating resistor 7 is introduced into membrane 3 a little outside of the middle of membrane 3 between the center of membrane 3 and measuring resistor 5.

Measuring resistor 14, introduced into membrane 3, is shifted in a direction that is parallel with respect to measuring resistor 5, and an imaginary mid-perpendicular to the longitudinal axis of measuring resistor 14 points with its one end approximately in the direction of the center of membrane 3, and with its other end approximately in the direction of “three o'clock”. Measuring resistor 14 is located in membrane 3 somewhat distant from the right edge of the membrane. Measuring resistor 8 is positioned in such a way that the longitudinal axis of measuring resistor 5 coincides approximately with the longitudinal axis of measuring resistor 8, and it is arranged substantially in mirror symmetry with respect to measuring resistor 5 on the opposite side of membrane 3.

An imaginary mid-perpendicular to the longitudinal axis of compensating resistor 10 coincides approximately with the longitudinal axis of measuring resistor 8, that is to say, compensating resistor 10 runs transversely with respect to measuring resistor 8. Compensating resistor 10, arranged substantially in parallel, i.e., in mirror symmetry with respect to compensating resistor 7, is disposed between measuring resistor 8 and the center of membrane 3.

Measuring resistor 11 in membrane 3 runs largely in parallel and at the same level as measuring resistor 14. It is introduced into membrane 3 substantially in mirror symmetry with respect to measuring resistor 14, in relation to measuring resistor 14, on the opposite side of membrane 3 near the left edge of the membrane.

Compensating resistor 16 is positioned on frame 2 of pressure sensor 1, parallel to measuring resistor 14. On the opposite side of frame 2, compensating resistor 13 is located on frame 2 of pressure sensor 1, its longitudinal axis running largely in parallel with respect to the longitudinal axis of measuring resistor 11. Compensating resistor 13 is situated at approximately the same level as measuring resistor 11.

As is explained in greater detail below in connection with FIG. 4, measuring resistors 5 and 14, as well as measuring resistors 11 and 8, in each instance form an arm of a measuring bridge (see position 50 in FIG. 4), that is to say, measuring resistor 11 is connected in series to measuring resistor 8, and measuring resistor 5 is connected in series to measuring resistor 14. Furthermore, compensating resistors 13 and 10, as well as compensating resistors 7 and 16, in each case form an arm of a compensating bridge (see position 51 in FIG. 4), that is, compensating resistor 13 is connected in series to compensating resistor 10, and compensating resistor 7 is connected in series to compensating resistor 16.

The arm of the measuring bridge formed from measuring resistors 11 and 8, as well as the arm of the measuring bridge formed from measuring resistors 5 and 14, respectively, are connected in parallel to each other.

In the same way, the arms of the compensating bridge formed from compensating resistors 13 and 10, as well as from 7 and 16, are connected in parallel.

A contact bank 17 for the connection of the supply voltage of pressure sensor 1 according to the present invention is electrically connected to the input of the measuring bridge formed by parallel-interconnected measuring resistors 11 and 5. Moreover, contact bank 17 is electrically connected to the input of the compensating bridge formed by parallel-connected compensating resistors 13 and 7. Contact banks 68 and 67 form the output of the measuring bridge, and contact banks 69 and 70 form the output of the compensating bridge. Connected to contact banks 17 and 28 is the voltage supply for pressure sensor 1 of the present invention, via which the measuring bridge and compensating bridge are each supplied with electric voltage. Contact bank 28 is the so-called bridge base point. Via a contact bank 67, that is connected to the line which connects measuring resistors 11 and 8 in series, as well as via a contact bank 68, which is electrically connected to the line that connects measuring resistors 5 and 14 in series, the electric voltage of sensor 1 present at the measuring outputs of measuring bridge 50 may be tapped off and supplied to compensation circuit 300 shown in FIG. 4.

In the same way, the electric line which connects compensating resistors 13 and 10 in series is electrically connected to a contact bank 69. A contact bank 70 is connected to the electric line which connects compensating resistors 13 and 10 in series. Via contact banks 69 and 70, the electric voltage of sensor 1 present at the measuring outputs of compensating bridge 51 may be tapped off and supplied to compensation circuit 300 shown in FIG. 4.

Contact banks 17, 68, 69, 28, 67 and 70 are arranged on frame 2 of pressure sensor 1 shown in FIG. 1. The electrical connections between the contact banks and the resistors, and between the different resistors, are achieved preferably by low-resistance printed circuit traces, whose interconnection with the resistors is shown schematically in FIG. 1, and is shown in an example embodiment in FIG. 2. Preferably, the printed circuit traces or electrical connections for forming the measuring bridge and the compensating bridge are attained by vapor deposition of the top side of frame 2 and of membrane 3 with a metal like, for example, aluminum, copper, gold or platinum.

Of course, the pressure sensor of the present invention may have further layers.

FIG. 2 shows in plan view the layout of a preferred example embodiment of the pressure sensor according to the present invention shown schematically in FIG. 1. The layout of pressure sensor 200 shown in FIG. 2, to the extent not indicated differently in the following, is identical with pressure sensor 1 shown in FIG. 1.

In particular, pressure sensor 200 shown in FIG. 2 deviates from pressure sensor 1 shown in FIG. 1, in that measuring resistor 5 of FIG. 1 is formed in FIG. 2 by two measuring resistors 5 and 6, measuring resistor 14 is formed by two measuring resistors 14 and 15, measuring resistor 8 is formed by two measuring resistors 8 and 9, and measuring resistor 11 is formed by two measuring resistors 11 and 12. Because, instead of one measuring resistor, a series connection made in each instance of two measuring resistors 5, 6; 14, 15; 8, 9; and 11, 12 is provided at the so-called first locations of the membrane at which the longitudinal and also transverse bending stress of the membrane is at a maximum, it is possible in a technically simple manner to form a measuring-bridge-50 resistor that is formed from two measuring resistors connected in series and has a high resistance value, preferably of at least 1 kΩ. The current consumption of a pressure sensor according to the present invention may thereby be markedly reduced. Moreover, due to the series connection of two measuring resistors, it is possible to produce “one” high-resistance measuring resistor by suitable doping of membrane 3 of pressure sensor 200.

Furthermore, due to the use of two measuring resistors according to the present invention, the offset may be minimized, and the ratio of the piezoresistance to the resistance of the leads may be maximized, thereby yielding a maximum sensitivity of the measuring system.

Accordingly, the resistors shown in FIG. 4 as individual resistors of Wheatstone measuring bridge 50, according to the preferred specific embodiment of pressure sensor 200 shown in FIG. 2, are actually in each case two measuring resistors connected in series.

A further difference of pressure sensor 200 shown in FIG. 2 compared to pressure sensor 1 shown in FIG. 1 is that frame resistors 13 and 16, positioned on frame 2 of pressure sensor 200, in each instance do not run parallel to measuring resistors 11 and 14. It may be that they are also arranged at approximately the same level as adjacent measuring resistors 11, 12 and 14, 15 located on membrane 3; however, the longitudinal axis of the frame resistors is rotated clockwise by in each case 45° compared to the longitudinal axis of the respective adjacent measuring resistor.

Of course, the alignment of frame resistors 13 and 16 on frame 2 orients itself to the specific crystal orientation of the frame or the semiconductor substrate from which the pressure sensor is produced. It is crucial that the alignment be implemented in such a way that the frame resistors are piezo-insensitive with respect to small deformations of the frame that may occur, thereby permitting a higher measuring accuracy.

Compensating resistors 13 and 16 arranged on frame 2 lie approximately half on the part of the frame which is formed by the unetched silicon substrate, and the other half on changeover region 4 between the silicon substrate and membrane 3. In addition, a space-saving arrangement is thereby achieved, so that the area of the silicon substrate needed altogether may be minimized, and the space saved may be used for the complete or partial implementation of the compensation circuit, shown in FIG. 4, on frame 2.

In observing FIG. 2, one notices that contact banks 17, 69, 28 and 70 are positioned more or less at the corners of the membrane on the upper side of pressure sensor 200 in changeover region 4. This advantageously yields a clear possibility for the external connection of pressure sensor 200 to a voltage supply, as well as the possibility of tapping off the voltage at the measuring outputs of the compensating bridge. Another advantage of this arrangement of the contact banks is that the connection of pressure sensor 200 is possible without negative effects on the deformation properties of membrane 3. In the same way, provided on the upper side of pressure sensor 200 in changeover region 4 are contact tabs 67 and 68, via which the voltage may be tapped off at the measuring outputs of the Wheatstone measuring bridge formed from the measuring resistors, and likewise how the signals or the voltage at the measuring outputs of compensating bridge 51 may be supplied via contact areas 69 and 70 to compensation circuit 300 shown in FIG. 4.

Moreover, to the extent possible, the printed circuit traces connecting the measuring resistors are predominantly disposed parallel to the respective membrane edge in its immediate vicinity on changeover region 4. In this manner, the printed circuit traces connecting the measuring resistors may be kept as short and therefore as low-resistance as possible.

Insofar as necessary, the printed circuit traces which connect compensating resistors 13 and 16, disposed on frame 2, to the compensating bridge, run on the left and the right side of the frame, respectively, and, in contrast to the printed circuit traces which connect the measuring resistors, have a greater distance to the respective adjacent membrane edges.

In the following, the layout of the interconnection of the printed circuit traces of pressure sensor 200 is described in detail. Contact bank 17 is connected via a lead 20 to the one terminal of compensating resistor 7. The other terminal of compensating resistor 7 is connected via a lead 21 to contact bank 69. Contact bank 69 is electrically connected via a printed circuit trace 19 to a connection point 23, which, on its part, is connected to the one terminal of compensating resistor 16 via a printed circuit trace 24. The other terminal of compensating resistor 16 is connected via a lead 25 to a contact point 26. Contact point 26 is connected via a printed circuit trace 27 to a point of intersection which, on its part, is formed by a printed circuit trace that is connected to a printed circuit trace 37 which contacts a terminal of measuring resistor 14. Moreover, the point of intersection is connected to a printed circuit trace 40 that electrically contacts a terminal of measuring resistor 9. Finally, the point of intersection is also electrically connected to contact bank 28, which, on its part, is connected to a terminal of compensating resistor 10 via a printed circuit trace 35. The other terminal of compensating resistor 10 is connected via a printed circuit trace 34 to contact bank 70, which, on its part, is in turn electrically connected via a printed circuit trace 32 to a contact point 31. A printed circuit trace 30 connects contact point 31 to a terminal of compensating resistor 13. The other terminal of compensating resistor 13 is electrically connected via a printed circuit trace 29, contact point 22, and subsequently via a printed circuit trace 18, to contact bank 17, whereby compensating bridge 51 is finally formed.

In addition, contact bank 17 is connected via printed circuit trace 18 to one terminal of measuring resistor 5, whose other terminal is connected via a contact bridge to a terminal of measuring resistor 6. The other terminal of measuring resistor 6 is connected via a printed circuit trace 36 to a terminal of measuring resistor 15. Printed circuit trace 36 is provided with contact tab 68 that points away from membrane 3 upward into changeover region 4. The other terminal of measuring resistor 15 is connected via a contact bridge to a terminal of measuring resistor 14. The other terminal of measuring resistor 14 is contacted by printed circuit trace 37. Printed circuit trace 40, connected to printed circuit trace 37, contacts a terminal of measuring resistor 9, which is connected via a contact bridge to a terminal of measuring resistor 8. The other terminal of measuring resistor 8 is electrically connected to a terminal of measuring resistor 11 via a printed circuit trace 39. Printed circuit trace 39 is made in part of contact tab 67 that points away from membrane 3 downward into changeover region 4. The other terminal of measuring resistor 11 is connected via a contact bridge to a terminal of measuring resistor 12, whose other terminal is electrically connected via a printed circuit trace 38 to printed circuit trace 18 and contact bank 17, whereby measuring bridge 50 is finally formed.

Leads 20, 21, 35 and 34, which contact compensating resistors 7 and 10 provided on membrane 3, each run approximately diagonally over a part of membrane 3 before they contact compensating resistors 7 and 10.

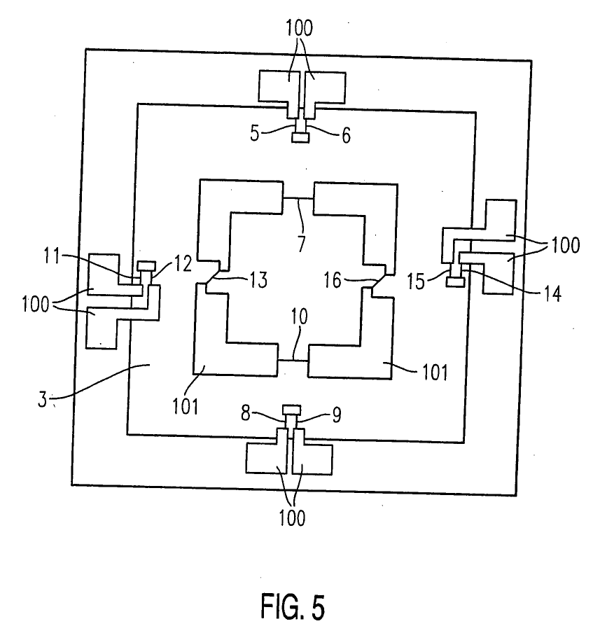

FIG. 5 shows a top view of a further exemplary embodiment of the pressure sensor according to the present invention. Reference numerals 5, 6, 8, 9, 11, 12, 14, 15 again designate measuring resistors which correspond to the measuring resistors as they were already described for FIG. 2. These measuring resistors are again arranged in an edge area of the membrane in which the resistance changes, occurring due to bending stresses, are at a maximum. Furthermore, compensating resistors 7, 10, 13, 16 are shown, compensating resistors 7 and 10 corresponding to compensating resistors 7 and 10 which were already described in FIG. 2. Also provided on the membrane according to FIG. 5 are compensating resistors 13 and 16 which correspond to compensating resistors 13 and 16 of FIG. 2, but, in contrast to FIG. 2, are disposed on membrane 3 in FIG. 5. The membrane is made of monocrystalline silicon, and all resistors are formed by suitable doping in the silicon. This variant is particularly space-saving.

As was already described for FIG. 2, measuring resistors 5, 6, 8, 9, 11, 12, 14, 15 and compensating resistors 7 and 10 are arranged parallel to the sides of rectangular membrane 3. These resistors are therefore placed in a crystal direction of the silicon in which the electrical resistance is a function of inner mechanical stresses (piezoresistive effect). However, compensating resistors 13 and 16 are oriented at an angle of 45° with respect to the rectangular side walls of membrane 3. Because of this alignment, compensating resistors 13 and 16 are placed in a crystal direction of monocrystalline silicon membrane 3 in which the dependence of the resistance upon mechanical stresses in monocrystalline silicon membrane 3 is minimal. However, measuring resistors 5, 6, 8, 9, 11, 12, 14, 15 and compensating resistors 7, 10 are placed in crystal directions in which a perceptible piezoresistive effect occurs, that is to say, the resistance of these elements is strongly dependent upon internal mechanical stresses in monocrystalline silicon membrane 3. The measuring resistors and compensating resistors are again interconnected to form bridges, as shown in FIG. 4 and described in the associated description. However, in contrast to FIG. 2, for reasons of simplification, the connection between the individual elements is not shown in FIG. 5. Connection regions 100 for the measuring resistors, which allow a contacting of the measuring resistor elements, are shown only schematically. For compensating resistors 7, 10, 13, 16, connection regions 101 by which the resistors on membrane 3 are interconnected are shown schematically. However, it is not shown how the contacting is effected outwardly. Because of the alignment of compensating resistors 13 and 16 in a direction in which no piezoresistive effect occurs, these resistors behave as if they were arranged on the frame, that is to say, they exhibit no or only a negligibly small resistance change as a result of a deformation of the membrane.

In the following, the functioning of pressure sensor 1 and 200 of the present invention, as represented by way of example in FIGS. 1, 2, 3 and 5, is clarified more precisely.

The relative change in resistance of a piezoresistive resistor, arranged in the membrane of the pressure sensor according to the present invention, as a function of the differential pressure between the two sides of the membrane may be described approximatively, disregarding terms of the third and higher order, as follows:

ΔR/R₀˜a(x,y,z) Δp+b(Δp)² (1)

where:

ΔR/R₀=the relative change in resistance of a piezoresistive resistor as a function of the differential pressure between the two sides of the membrane;

Δp=the differential pressure between the two sides of the membrane;

x,y,z=the spatial coordinates of the (reduced to a single point for the sake of simplicity) specific location of the piezoresistive resistor in relation to the membrane;

a=a factor which is a function of the piezoresistive resistor in question, its location in relation to the specific membrane, the specific membrane and the specific sensor;

b=a location-independent factor which is a function of the piezoresistive resistor in question, its location in relation to the specific membrane, the specific membrane and the specific sensor;

a(x,y,z) Δp=a location-dependent, linear component of the relative change in resistance as a result of a change in the radial and tangential bending stress;

b (Δp)²=a location-independent, quadratic component of the relative change in resistance as a result of the change in the location-independent membrane stress.

Typically, factor b of the quadratic term of the above equation (1) is markedly smaller than factor a of the linear term of the relative change in resistance of a piezoresistive resistor, disposed in a membrane, as a function of the differential pressure between the two sides of the membrane. If the differential pressure between the two sides of the membrane is relatively small, the relative change in resistance is determined largely by the linear term of equation (1).

However, if a piezoresistive resistor is now used in a micromechanical pressure sensor for measuring a pressure in the low-pressure range—typically a range of approximately 0 to 50 mbar for the pressure sensor according to the present invention—and the membrane separates the low-pressure range, for example, from the vacuum, then, with increasing differential pressure, i.e., in this example, the increase of the differential pressure from approximately 0 to approximately 50 mbar, the quadratic term of the equation becomes noticeable compared to the linear term of the equation. The same also holds true accordingly, for example, for a situation in which normal pressure or atmospheric pressure prevails on the one side of the membrane, and on the other side of the membrane, a pressure prevails which is higher or lower in the range of approximately 0 to 50 mbar.

The result is that, with increasing differential pressure, the resistance curve of the piezoresistive resistor exhibits a (usually unwanted) non-linear characteristic.

A first aspect of the present invention for solving this problem is to design the measuring resistor(s) (see FIGS. 1, 2 and 3), introduced into the membrane of a micromechanical pressure sensor according to the invention, in their form and in their dimensions in such a way that in each case, they may be introduced into the membrane at such points or locations of the membrane at which the total stress, composed generally of the linear bending stress and the quadratic membrane stress, is great, preferably substantially at a maximum.

Because the measuring resistor(s) is/are disposed at this/these location(s) of the membrane, compared to other locations of the membrane which do not have these properties, a high, preferably a substantially maximum relative change in resistance results as a function of the differential pressure between the top side and the bottom side of the membrane, and therefore an improved possibility for measuring the differential pressure based on the evaluation of the relative change in resistance.

A second aspect of the present invention for solving the indicated problem of nonlinearity is to construct one or more membrane compensating resistors (see FIGS. 1, 2 and 3) in their shape and in their dimensions so that in each instance they may be arranged at a point or a location of the membrane at which the membrane stress running quadratically with the differential pressure acts almost exclusively on the membrane compensating resistor in question.

As regards EP 0 833 137 and WO 01/40751, the assumption has been that an optimum location for the membrane compensating resistor(s) in the membrane should be selected so that a “minimum” bending stress of the membrane is present at it. Meant by this was apparently a minimum of radial bending stress σ₁, which may be expressed as:

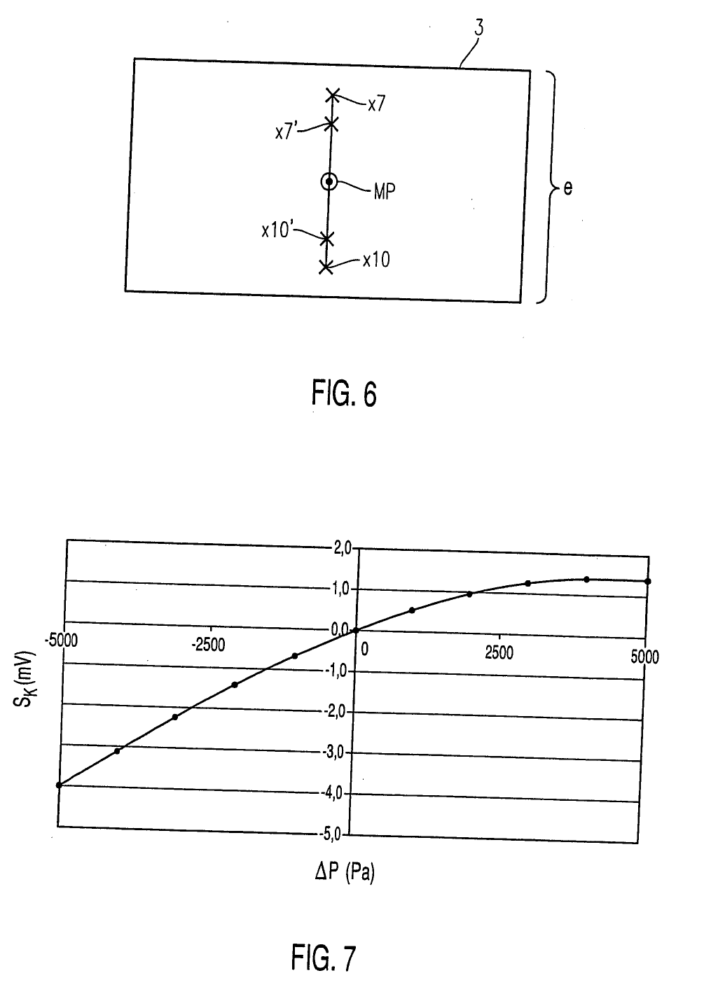

σ₁=const. x ΔP x(1−3(2x/1)²) (2)

where 1 designates the length of the membrane and ΔP designates the differential pressure. The variable x is the distance from the middle of the membrane (see FIG. 6).

The zero value of radial bending stress a, according to equation (2) is given by

x/(½)=(⅓)^{0.5}≈0.58 (3)

where x designates the distance from the middle of the membrane.

The locations at which disappearing radial bending stresses are present in the membrane shall now be explained with reference to FIG. 3. FIG. 3 shows a cross-section through a pressure sensor element. When membrane 3 deforms upwardly in FIG. 3, then compressive stresses act on measuring resistors 8 and 5, which are situated on the upper side of membrane 3. Between these two resistors, approximately in the middle of the membrane, tensile stresses act on the upper side of the membrane, that is to say, in response to a deformation upward, the upper side of the membrane has compressive stresses in the edge area and tensile stresses in the middle. Between these regions with compressive stresses and tensile stresses is a neutral zone, in which no radial bending stresses occur. According to the related art, it is at these locations that the compensating resistors are arranged, which are then not acted upon by bending stresses.

If the membrane, as it is shown in FIG. 3, is deformed downward, then tensile stresses act on the edge areas of the membrane in which measuring resistors 5 and 8 are positioned, and compressive stresses act on a middle region of the membrane. Between these tensile stresses and compressive stresses, there is again a region in which no bending stresses occur on the upper side of the membrane, and in which compensating resistors 7 and 10 are then arranged accordingly.

For the specific layout of a sensor according to the related art, the location must naturally be determined at which precisely no radial bending stresses occur on the upper side of the membrane.

FIG. 6 shows a schematic representation of the configuration of the compensating resistors according to the present invention in comparison to the configuration in the case of the pressure sensor device described in EP 0 833 137 or WO 01/40751.

In FIG. 6, MP designates the midpoint of membrane 3; x7 and x10 designate the x-distances of compensating resistors 7 and 10, respectively, from the midpoint MP of the membrane for the pressure sensor device described in EP 0 833 137 or WO 01/40751, which are calculated from the above equation (2).

x7′ and x10′ are the x-distances of compensating resistors 7 and 10, respectively, from midpoint MP of the membrane for the pressure sensor device according to the present invention, which are less than x7 and x10.

For a typical low pressure sensor where 1=1800 μm, then x7′/1=x10′/1=0.49, for example, results as the optimum value in comparison to 0.58 according to equation 2.

FIG. 7 shows a representation of output signal S_{K}(mV) of the pressure sensor device having compensating resistors 7, 10, arranged according to EP 0 833 137, as a function of the applied differential pressure ΔP (bar), thus at distances x7/1=x10/1=0.58 according to FIG. 6.

The presence of a linear component is clearly discernible, with the result that an addition of the measuring-resistor signal and the compensating-resistor signal does not lead to the desired linearization of the measuring-resistor signal.

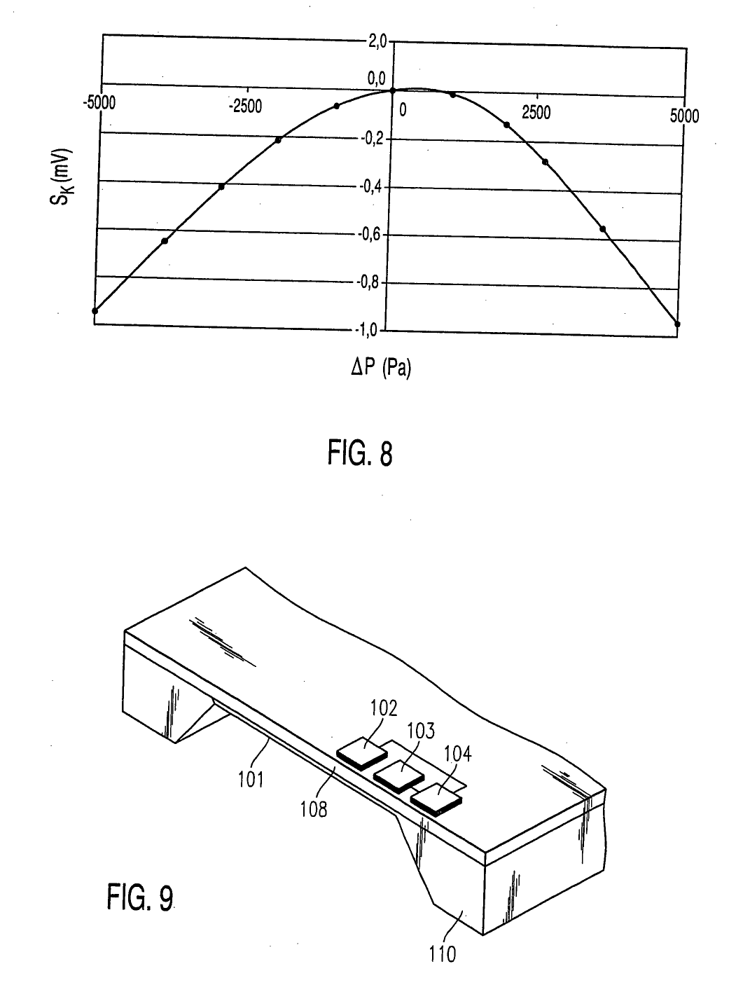

FIG. 8 shows a representation of output signal S_{K}(mV) of the pressure sensor device, having compensating resistors arranged according to the present invention, as a function of the applied differential pressure ΔP (bar), thus at distances x7′/1=x10′/1=0.49 according to FIG. 6.

Clearly discernible is the nearly complete absence of a linear component, with the result that an addition of the measuring-resistor signal and the compensating-resistor signal leads to the desired linearization of the measuring-resistor signal.

In contrast to EP 0 833 137 and WO 01/40751, according to the present invention, the compensating resistors are not arranged at the location according to equation (3), but rather at locations nearer to midpoint MP of membrane 3, which exhibit the almost purely quadratic pressure dependence of the compensating-resistor signal according to FIG. 8.

These locations x7′ and x10′ may be determined either with the aid of calculations, particularly finite element calculations, or else empirically by measurement.

In the calculations, the above-indicated coefficient a(x,y,z) for the pressure dependence of the compensating-resistor signal, the coefficient of the linear component, is minimized, taking into account the influence of radial bending stress σ₁ and the influence of tangential bending stress σₜ.

In particular, tangential bending stress σₜ, starting from the middle of the membrane, where σ₁=σₜ, decreases with the square of the cosine of the distance toward the edge of the membrane.

The relative change in resistance, taking into account tangential bending stress σₜ, is yielded at:

ΔR/R₀=π₁ σ₁+πₜ σₜ (4)

where π₁ and πₜ are constant coefficients of different algebraic signs. The result is that, by suitable selection of the distance of the compensating resistor from the middle of the membrane, a location may be found at which linear component a(x,y,z) disappears. However, this is not the location at which σ₁=0.

For the sake of completeness, it should be mentioned that any frame resistors not provided in the membrane and located on or in the frame of the pressure sensor are substantially pressure-independent, because a pressure acting on the upper side or lower side of the membrane leads at most to a very slight deformation of the frame, the deformation of the frame being very small compared to the deformation of the membrane. However, to also rule out to a great extent the possibility of a change in resistance of a piezoresistive frame resistor as a result of a deformation of the frame of the pressure sensor, a further example embodiment of the present invention provides for arranging the frame resistor in such a way in relation to the crystal orientation of the frame that the resistor is not influenced by the deformation of the frame, that is to say, that it has a piezo-insensitive alignment with respect to the crystal orientation of the frame.

Of course, use is also made of the principle according to the present invention when the measuring resistors and/or compensating resistors are merely arranged near the above-described (ideal) points or locations of the membrane or of the frame of the pressure sensor.

Because of the above-described interconnection of the measuring resistors, provided at the membrane locations according to the present invention, to form a measuring bridge, the following bridge voltage results at contact banks 67 and 68, the outputs of the measuring bridge:

U_{measuring bridge} (Δp)=((Rₜ−R₁)/(Rₜ+R₁))Uᵥ (5)

where:

U_{measuring bridge}=the electric voltage as a result of differential pressure Δp between the two sides of the membrane between the two arms of the measuring bridge, which is tapped off at contact banks 67 and 68 of the example pressure sensor according to the present invention;

Rₜ=the electrical resistance of the piezoresistive resistors of the measuring bridge, which is a function of the transverse bending stress at the piezoresistive measuring resistors as a result of differential pressure Δp between the two sides of the membrane;

R₁=the electrical resistance of the piezoresistive resistors of the measuring bridge, which is a function of the longitudinal bending stress at the piezoresistive measuring resistors as a result of differential pressure Δp between the two sides of the membrane;

Uᵥ=the electric voltage of the supply voltage which is applied at contact banks 17 and 28 of the pressure sensor according to the present invention.

From this equation (5) for the output voltage of the measuring bridge, it becomes clear that the nonlinearity of the individual resistors leads to a nonlinearity of the bridge voltage of the measuring bridge.

The compensating bridge, formed from two pressure-independent, piezoresistive resistors on the frame of the membrane and two pressure-dependent compensating resistors at the locations according to the present invention on the membrane of the pressure sensor according to the present invention, has at contact banks 69 and 70, the measuring outputs of the compensating bridge, an electric voltage which may be described approximatively by the following equation:

U_{compensating bridge}=((R_{comp}−R₀)/(R_{comp}+R₀))Uᵥ (6)

where:

U_{compensating bridge}=the electric voltage of the compensating bridge as a result of differential pressure Δp between the two sides of the membrane, which is tapped off at contact banks 69 and 70 of the pressure sensor according to the present invention;

R_{comp}=the electrical resistance of the compensating bridge;

R₀=R_{comp} (for Δp=0): the electrical resistance of the compensating bridge for a differential pressure Δp=0;

Uᵥ=the supply voltage of the compensating bridge.

Given a suitable electrical connection of the compensating-bridge outputs, formed by contact banks 69 and 70, and the measuring-bridge outputs, formed by contact banks 67 and 68, one obtains an output voltage of the compensating bridge (U_{compensating bridge}) as a function of differential pressure (Δp), which has an inverted sign compared to the output voltage of the measuring bridge (U_{measuring bridge}).

Moreover, the compensating bridge has a lower sensitivity than the measuring bridge, and the nonlinearity of the compensating bridge is perceptibly higher than the nonlinearity of the measuring resistors provided in the membrane, i.e., of the output signal of the measuring bridge. This is established by the above-described arrangement of the membrane-compensating resistors at, in each case, a location of the membrane at which predominately just the membrane stress (location-independent and proportional to (Δp)²) acts on the membrane-compensating resistors.

An aspect of the present invention for reducing the nonlinearity of the output voltage (see FIG. 4) of the measuring resistors in the membrane, interconnected to form a measuring bridge 50, is now to subtract the first electric current, produced by a first voltage-/current transducer 54 from the nonlinear output voltage of compensating bridge 51, at transducer output 60, from the second electric current, produced by a second voltage-/current transducer 53 from the nonlinear output voltage of measuring bridge 50, at transducer output 59. According to the present invention, the interconnection is implemented in such a way that the first electric current has an inverted sign with respect to the second electric current, and the quadratic components of both currents completely or partially offset or compensate each other.

As FIG. 4 shows, the first electric current of voltage-/current transducer 54 of compensating bridge 51 to be subtracted is amplified prior to the subtraction so that the absolute value of the component of the first electric current, running quadratically with the differential pressure, at output 60 corresponds essentially to the absolute value of the component of the second electric current, running quadratically with the differential pressure, at output 59. The result is then an electric current (see line 61 in FIG. 4) which exhibits a substantially linear characteristic as a function of the differential pressure, and is used for determining the differential pressure. For the adjustment of voltage-/current transducer 54, i.e., for the amplification of the first electric current prior to the subtraction of the electric currents, voltage-/current transducer 54 is provided with a terminal 52 for the feed of an adjustable compensating voltage.

To keep the current consumption by the pressure sensor of the present invention as low as possible, the resistors preferably have an electrical resistance that is greater than 1 kΩ.

### Reference Numeral List

1 pressure sensor

2 frame

3 membrane

4 changeover region

5 measuring resistor

6 measuring resistor

7 membrane-compensating resistor

8 measuring resistor

9 measuring resistor

10 membrane-compensating resistor

11 measuring resistor

12 measuring resistor

13 frame resistor

14 measuring resistor

15 measuring resistor

16 frame resistor

17 contact bank

18 printed circuit trace

19 printed circuit trace

20 lead

21 lead

22 contact point

23 connection point

24 printed circuit trace

25 printed circuit trace

26 contact point

27 printed circuit trace

28 contact bank

30 printed circuit trace

31 contact point

32 printed circuit trace

34 lead

35 lead

36 printed circuit trace

37 printed circuit trace

38 printed circuit trace

39 printed circuit trace

40 printed circuit trace

41 cavity

50 measuring bridge

51 compensating bridge

52 terminal for the adjustment of the voltage-/current

transducer of the compensating bridge

53 voltage-/current transducer

54 voltage-/current transducer

59 output of a voltage-/current transducer

60 output of a voltage-/current transducer

61 line

67 contact tab

68 contact tab

69 contact bank

70 contact bank

200 pressure sensor

300 compensation circuit

What is claimed is:

1. A micromechanical pressure sensor device for measuring at least one of low absolute pressures and small differential pressures, comprising:
a frame that is formed at least partially by a semiconductor material;
a membrane retained by the frame;
at least one measuring resistor arranged at a first location in or on the membrane, the at least one measuring resistor having a resistance value that is function of pressure-induced mechanical stresses in the membrane; and
at least one compensating resistor arranged at a second location in or on the membrane, the at least one compensating resistor having a resistance value that is a function of pressure-induced mechanical stresses in the membrane, the resistance value of the at least one measuring resistor changing at the first location with a first linear component and a first quadratic component as a function of the pressure, and the resistance value of the at least one compensating resistor changing at the second location approximatively without a linear component and with a second quadratic component, which is proportional to the first quadratic component, as a function of the pressure.

2. The pressure sensor device as recited in claim 1, wherein the at least one measuring resistor includes at least four measuring resistors, each of which being arranged at a respective first location of the membrane, and wherein the at least four measuring resistors are interconnected to form a first ring circuit configuration.

3. The pressure sensor as recited in claim 2, wherein the at least four measuring resistors are interconnected to form a Wheatstone measuring bridge.

4. The pressure sensor as recited in claim 2, wherein the at least four measuring resistors are interconnected to form a measuring transducer.

5. The pressure sensor device as recited in claim 1, wherein the at least one compensating resistor includes at least two compensating resistors, each of which being arranged at a respective second location of the membrane, and wherein the pressure sensor device further comprises:
at least two further compensating resistors, the compensating resistors and the at least two further resistors being interconnected to form a second ring circuit configuration.

6. The pressure sensor device as recited in claim 5, wherein the second ring circuit configuration is a Wheatstone bridge.

7. The pressure sensor device as recited in claim 5, wherein the second ring configuration is a compensating bridge.

8. The pressure sensor device as recited in claim 5, wherein the at least two further compensating resistors are disposed on the frame.

9. The pressure sensor device as recited in claim 5, wherein the at least two further compensating resistors are disposed on the membrane.

10. The pressure sensor device as recited in claim 5, wherein the at least two further compensating resistors are arranged in such a way that an electrical resistance of the two further compensating resistors remains substantially constant, even in an event of a deformation.

11. The pressure sensor device as recited in claim 1, wherein at least one of the: i) measuring resistors, and ii) the compensating resistor is a piezoresistive resistor.

12. The pressure sensor device as recited in claim 8, wherein at least one of the further compensating resistors is positioned in such a way that it is substantially piezo-insensitive with respect to a deformation of the frame.

13. A measurement system for measuring at least one of absolute pressure and differential pressure, comprising:
a frame that is formed at least partially by a semiconductor material;
a membrane retained by the frame;
at least one measuring resistor arranged at a first location in or on the membrane, the at least one measuring resistor having a resistance value that is function of pressure-induced mechanical stresses in the membrane;
at least one compensating resistor arranged at a second location in or on the membrane, the at least one compensating resistor having a resistance value that is a function of pressure-induced mechanical stresses in the membrane, the resistance value of the at least one measuring resistor changing at the first location with a first linear component and a first quadratic component as a function of the pressure, and the resistance value of the at least one compensating resistor changing at the second location approximatively without a linear component and with a second quadratic component, which is proportional to the first quadratic component, as a function of the pressure;
first means for detecting a change in the resistance value produced by the pressure difference at the at least one measuring resistor; and
second means for detecting a change in the resistance value produced by the pressure difference at the at least one compensating resistor.

14. The measurement system as recited in claim 13, wherein the at least one measuring resistor includes four measuring resistors forming a Wheatstone measuring bridge, the first means detecting a change in voltage produced by a pressure difference between arms of the Wheatstone measuring bridge, and wherein the at least one compensating resistor includes two compensating resistors and two bridge resistors forming a Wheatstone compensating bridge, the second means detecting a change in voltage produced by a pressure difference between arms of the Wheatstone compensating bridge.

15. The measurement system as recited in claim 13, wherein the first means has a first voltage-current transducer via whose input a voltage change produced by the pressure difference is detected, a first electrical current, which is proportional to an input voltage at the first voltage-current transducer, being delivered via an output of the first voltage-current transducer, and wherein the second means has a second voltage-current transducer, via whose input a voltage change produced by the pressure difference is detected, a second electrical current, which is proportional to an input voltage at the second voltage-current transducer, being delivered via an output of the second voltage-current transducer, the second electrical current having an inverted sign with respect to the first electrical current, and wherein the measurement system further comprises:
a compensation circuit configured to the second electrical current and an amplified second electrical current from the first electrical current.

16. The measurement system as recited in claim 15, further comprising:
an amplifier configured to amplify the second electrical current delivered by the second voltage-current transducer.
